(19) United States
(12) Patent Application Publication
(10) Pub. No.: US 2024/0009043 A1
(43) Pub. Date: Jan. 11, 2024

(54) DRY ERASE BOARD FOR USE WITH A STRETCHER OR HOSPITAL BED

(71) Applicant: MEGAN RUSSELL, Farmingville, NY (US)

(72) Inventor: MEGAN RUSSELL, Farmingville, NY (US)

(21) Appl. No.: 17/857,628

(22) Filed: Jul. 5, 2022

(51) Int. Cl. A61G 1/04; B43L 1/00

(52) U.S. Cl. CPC A61G 1/04; B43L 1/00; A61G 7/05

(57) ABSTRACT

The dry erase board for use with a stretcher or hospital bed comprises a dry erase board, a dry erase marker, non-erasable indicia, a mount, and a digital clock. The dry erase board may be coupled to a patient conveyance using the mount. The non-erasable indicia may be adapted to provide a plurality of prompts for caregivers to write information relevant to the care of a patient on the dry erase board using the dry erase marker. The digital clock may conveniently display the time of day. As non-limiting examples, the patient conveyance may be a stretcher or hospital bed. As a non-limiting example, the layout, phrases, and keywords of the non-erasable indicia may be associated with the Hospital Consumer Assessment of Healthcare Providers and Systems (HCAHPS) patient survey data from the Centers for Medicare and Medicaid Services (CMS).

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the fields of medical communications systems and patient conveyance, more specifically, a dry erase board for use with a stretcher or hospital bed.

### SUMMARY OF INVENTION

The dry erase board for use with a stretcher or hospital bed comprises a dry erase board, a dry erase marker, non-erasable indicia, a mount, and a digital clock. The dry erase board may be coupled to a patient conveyance using the mount. The non-erasable indicia may be adapted to provide a plurality of prompts for caregivers to write information relevant to the care of a patient on the dry erase board using the dry erase marker. The digital clock may conveniently display the time of day. As non-limiting examples, the patient conveyance may be a stretcher or hospital bed. As a non-limiting example, the layout, phrases, and keywords of the non-erasable indicia may be associated with the Hospital Consumer Assessment of Healthcare Providers and Systems (HCAHPS) patient survey data from the Centers for Medicare and Medicaid Services (CMS).

An object of the invention is to provide a dry erase board that may be coupled to a patient conveyance.

Another object of the invention is to provide non-erasable indicia on the marking surface of the dry erase board to serve as a plurality of prompts for the caregivers.

A further object of the invention is to provide a digital clock that is coupled to the frame of the dry erase board.

Yet another object of the invention is to mount the dry erase board to the patient conveyance using via a ball joint and a clamp.

These together with additional objects, features and advantages of the dry erase board for use with a stretcher or hospital bed will be readily apparent to those of ordinary skill in the art upon reading the following detailed description of the presently preferred, but nonetheless illustrative, embodiments when taken in conjunction with the accompanying drawings.

In this respect, before explaining the current embodiments of the dry erase board for use with a stretcher or hospital bed in detail, it is to be understood that the dry erase board for use with a stretcher or hospital bed is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the dry erase board for use with a stretcher or hospital bed.

It is therefore important that the claims be regarded as including such equivalent construction insofar as they do not depart from the spirit and scope of the dry erase board for use with a stretcher or hospital bed. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a rear view of an embodiment of the disclosure.

FIG. 3 is a side view of an embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

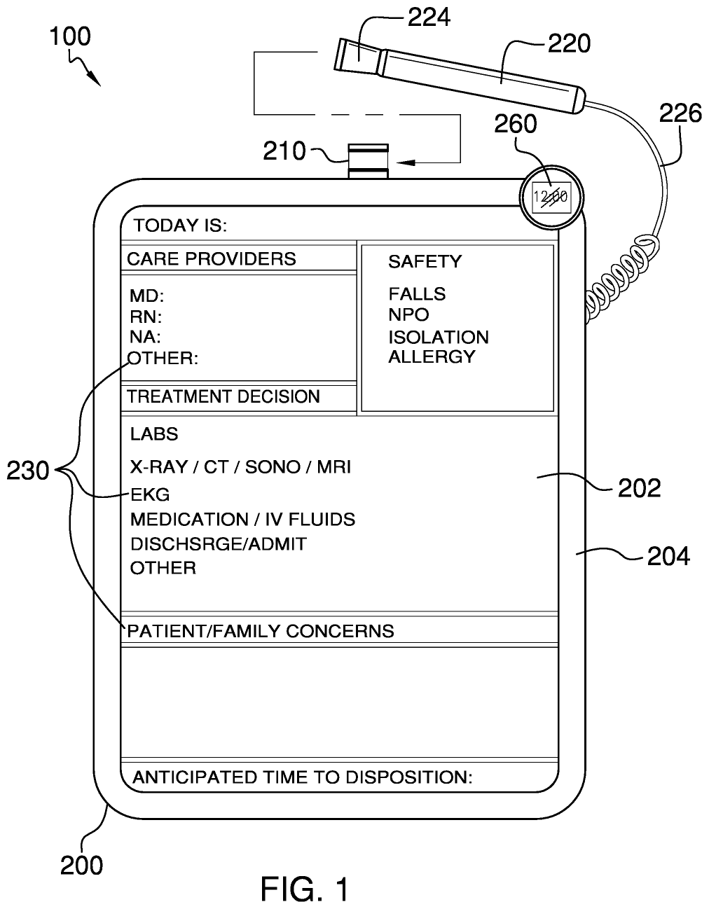

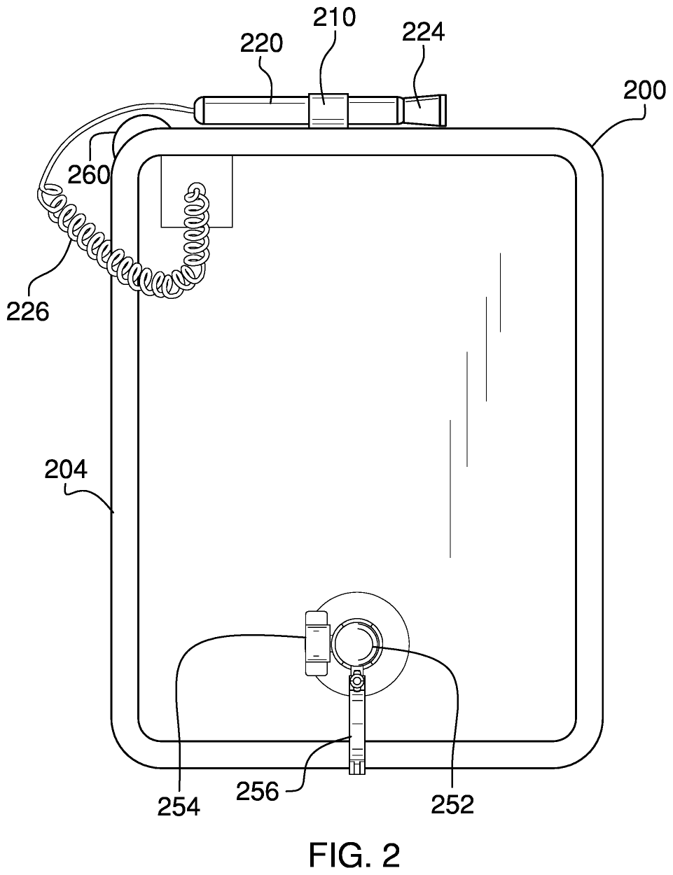

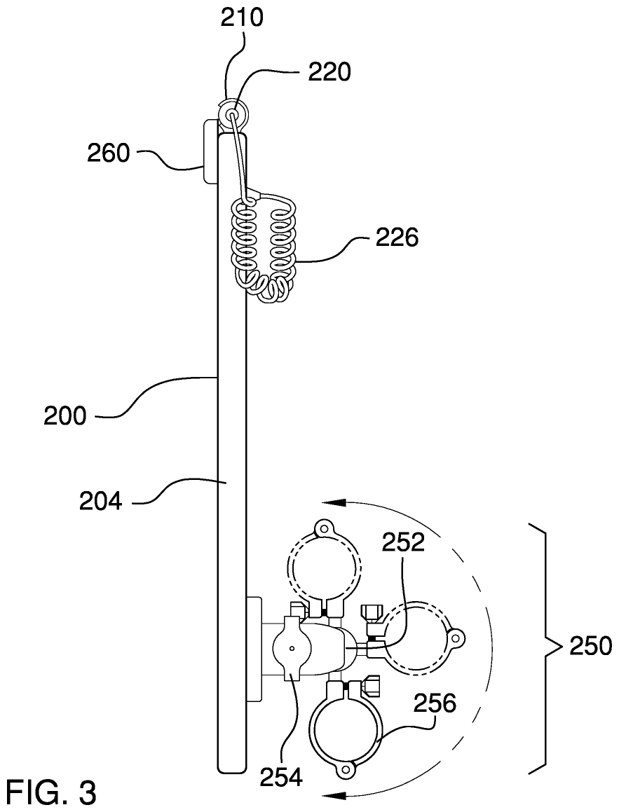

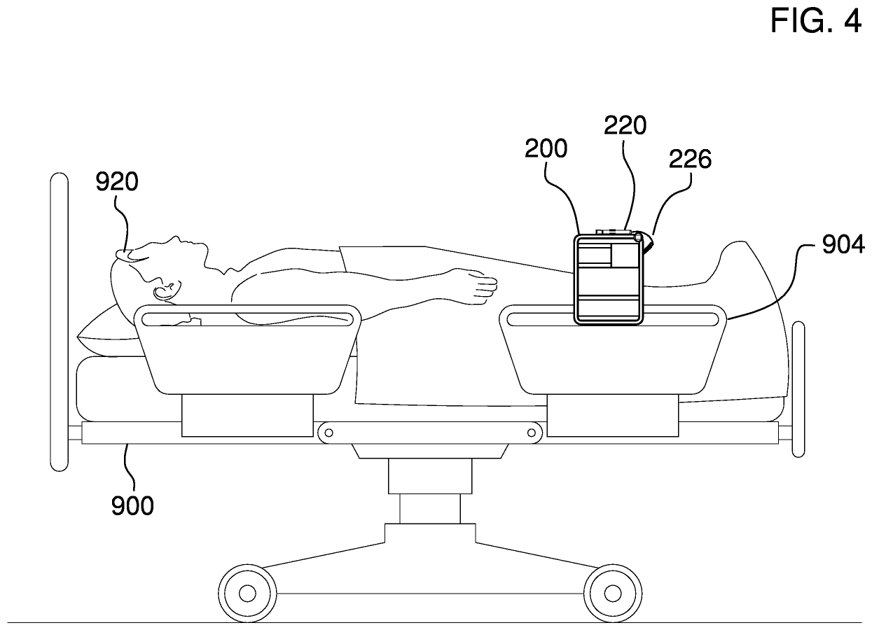

Detailed reference will now be made to a first potential embodiment of the disclosure, which is illustrated in FIGS. 1 through 4.

The dry erase board for use with a stretcher or hospital bed 100 (hereinafter invention) comprises a dry erase board 200, a dry erase marker 220, non-erasable indicia 230, a mount 250, and a digital clock 260. The dry erase board 200 may be coupled to a patient conveyance 900 using the mount 250. The non-erasable indicia 230 may be adapted to provide a plurality of prompts for caregivers to write information relevant to the care of a patient 920 on the dry erase board 200 using the dry erase marker 220. The digital clock 260 may conveniently display the time of day. As non-limiting examples, the patient conveyance 900 may be a stretcher or hospital bed. As a non-limiting example, the layout, phrases, and keywords of the non-erasable indicia 230 may be associated with the Hospital Consumer Assessment of Healthcare Providers and Systems (HCAHPS) patient survey data from the Centers for Medicare and Medicaid Services (CMS).

The dry erase board 200 may comprise a marking surface 202 retained within a frame 204. The marking surface 202 may be a non-matte, non-porous surface that may be impermeable to ink left behind by passing the dry erase marker 220 over the marking surface 202. Traditionally, the marking surface 202 is white such that dark colored markers may be used on the marking surface 202.

The dry erase board 200 may comprise a marker holder 210 that is coupled to the frame 204 and is configured to retain the dry erase marker 220 when the dry erase marker 220 is not in use.

The dry erase marker 220 may be a marking pen that may deposit an erasable ink onto the dry erase board 200 when a marking tip of the dry erase marker 220 is moved while in contact with the dry erase board 200. The marking tip of the dry erase marker 220 may be covered by a cap 224 when not in use to prevent accidental markings. The dry erase marker 220 may be coupled to the frame 204 of the dry erase board 200 via a tether 226 to prevent loss of the dry erase marker 220.

The non-erasable indicia 230 may be textual and/or graphical sentiments appearing on the marking surface 202. The non-erasable indicia 230 may be permanent in the sense that the non-erasable indicia 230 may remain on the marking surface 202 after erasing marks left by the dry erase marker 220. The sentiments expressed by the non-erasable indicia 230 may be adapted to prompt the caregivers to add information relevant to the care of the patient 920 using the dry erase marker 220. As a non-limiting example, the non-erasable indicia 230 may be silk-screened onto the marking surface 202 using a paint that may bond permanently with the marking surface 202 once the paint has dried.

The plurality of prompts may be organized and grouped such that the plurality of prompts are adapted to communicate specific messages and status to both the caregivers and to the patient 920. The plurality of prompts may prompt for a current date and names of care providers. The plurality of prompts may prompt for safety information. As non-limiting examples, the safety information may comprise fall tracking, nothing by mouth, isolation due to infectious condition, and patient allergies. The plurality of prompts may prompt for treatment decisions. The plurality of prompts may prompt for labs. As non-limiting examples, the labs may comprise bloodwork, urine, radiology, ultrasound, X-ray, EKG, etc. The plurality of prompts may prompt for medication and IV fluids. The plurality of prompts may prompt for a discharge/admission decision. The plurality of prompts may prompt for notes. As non-limiting examples, the notes may comprise patient concerns and family concerns. The plurality of prompts may prompt for treatment timing.

The mount 250 may be operable to detachably couple the dry erase board 200 to the patient conveyance 900. As a non-limiting example, the mount 250 may detachably couple to a siderail 904 of the stretcher carrying the patient 920. The dry erase board 200 may therefore be moved out of the way to access the patient 920 when the siderail 904 is dropped out of the way. The mount 250 may be coupled to the rear of the dry erase board 200. The mount 250 may comprise a ball joint 252 and a clamp 256.

The ball joint 252 may be operable to change the elevation angle, the azimuth angle, or both between the dry erase board 200 and the patient conveyance 900. The ball joint 252 may permit the dry erase board 200 to be repositioned when an adjustment knob 254 is rotated to loosen the ball joint 252. The ball joint 252 may prevent the dry erase board 200 to be repositioned when the adjustment knob 254 is rotated to tighten the ball joint 252. The clamp 256 may be opened to couple the mount 250 to the patient conveyance 900 and may be closed to retain the mount 250 to the patient conveyance 900.

The digital clock 260 may be a time-keeping device coupled to the front of the dry erase board 200. The digital clock 260 may display the local time. The digital clock 260 may improve the hospital experience for the patient 920 because it may be difficult to keep track of time within a hospital, especially in an emergency room, without having the digital clock 260 available.

In use, the invention 100 may be coupled to a patient conveyance 900 where the dry erase board 200 may be viewed by caregivers, the patient 920, or both. As a non-limiting example, the clamp 256 may be coupled to a siderail 904 of a stretcher and the ball joint 252 may enable the dry erase board 200 to change viewing angles. The caregivers may update the dry erase board 200 using the dry erase marker 220 in accordance with a plurality of prompts appearing as non-erasable indicia 230 on the dry erase board 200.

### Definitions

As used in this disclosure, the “azimuth” or azimuth angle, refers to an angle that is measured in a plane that is perpendicular to the either the vertical direction or the force of gravity.

As used herein, “ball joint” may refer to a type of ball and socket coupling that allows at least limited rotation around three perpendicular axis.

As used herein, “caregiver” may refer to a person who provides care for a person in need of care. As non-limiting examples, the care may comprise managing medications, performing hygiene related tasks, providing meals, reading, conversation, housecleaning, transportation, or any combination thereof. The caregiver may be paid or unpaid. As non-limiting examples, caregivers may comprise doctors, nurses, interns, orderlies, adult family members, hospital/hospice staff and/or volunteers, and neighbors.

As used in this disclosure, a “clock” may be an instrument that measures the passage of time. Clocks are often synchronized to a reference time that allows for communities to coordinate the scheduling of activities.

As used herein, “CMS” may refer to the Centers for Medicare & Medicaid Services. CMS is a federal agency that administers Medicare and works in partnership with state government to administer Medicaid, CHIPS, and health insurance portability standards.

As used herein, the words “couple”, “couples”, “coupled” or “coupling”, may refer to connecting, either directly or indirectly, and does not necessarily imply a mechanical connection.

As used herein, the words “data” and “information” may be used interchangeably to refer to raw, unprocessed facts and to facts that have been processed, structured, organized, or presented in a context that makes the facts useful.

As used herein, “dry erase marker” may refer to a marking pen that may dispense an erasable ink onto glossy, non-porous surfaces. The erasable ink typically comprises a quick-drying solvent such as one or more alcohols, a pigment to provide a desired color, and a release agent to prevent the pigment from bonding with a glossy, non-porous surface. As the name implies, the erasable ink may be erased by wiping a dry eraser over the surface even after the solvent has evaporated.

As used herein, “elevation angle” may refer to the angle between a line and the horizon.

As used herein, “front” may indicate the side of an object that is closest to a forward direction of travel under normal use of the object or the side or part of an object that normally presents itself to view or that is normally used first. “Rear” or “back” may refer to the side that is opposite the front.

As used herein, “HCAHPS” may refer to Hospital Consumer Assessment of Healthcare Providers and Systems. HCAHPS comprises a standardized survey instrument and data collection methodology that measures patients' perspectives of hospital care.

As used in this disclosure, the term “indicia” may refer to a set of markings that identify a sentiment.

As used in this disclosure, a “patient” may be a person who is designated to receive a medical treatment, therapy, or service. The term patient may be extended to an animal when used within the context of the animal receiving veterinary treatment or services

As used herein, the words “printed”, “marked”, and “marking” may refer to a mark that has been made on an object. The process of making the mark may involve printing, lithography, thermal transfer, painting, embossing, molding, burning, silk-screening, drawing, etching, engraving, stenciling, stamping, spraying of pigments, or other processes which result in the controlled change of coloration and/or shape of a surface.

As used in this disclosure, a “tether” may be a cord, line, webbing, cable, or strap that is attached to an object to restrict movement.

As used herein, “whiteboard” may refer to a surface that is designed to receive non-permanent markings that can be used for communication or recording purposes. The non-permanent markings may be erased by wiping the surface with an eraser, paper towel, or cloth which does not require dampening (hence the term dry-erase). Whiteboards are also commonly referred to as “dry erase boards”.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A dry erase board for use with a stretcher or hospital bed comprising:
a dry erase board, a dry erase marker, non-erasable indicia, a mount, and a digital clock;
wherein the dry erase board is coupled to a patient conveyance using the mount;
wherein the non-erasable indicia are adapted to provide a plurality of prompts for caregivers to write information relevant to the care of a patient on the dry erase board using the dry erase marker;
wherein the digital clock displays the time of day.

2. The dry erase board for use with a stretcher or hospital bed according to claim 1
wherein the dry erase board comprises a marking surface retained within a frame;
wherein the marking surface is a non-matte, non-porous surface that is impermeable to ink left behind by passing the dry erase marker over the marking surface.

3. The dry erase board for use with a stretcher or hospital bed according to claim 2
wherein the dry erase board comprises a marker holder that is coupled to the frame and is configured to retain the dry erase marker when the dry erase marker is not in use.

4. The dry erase board for use with a stretcher or hospital bed according to claim 3
wherein the dry erase marker is a marking pen that deposits an erasable ink onto the dry erase board when a marking tip of the dry erase marker is moved while in contact with the dry erase board;
wherein the marking tip of the dry erase marker is covered by a cap when not in use to prevent accidental markings.

5. The dry erase board for use with a stretcher or hospital bed according to claim 4
wherein the dry erase marker is coupled to the frame of the dry erase board via a tether to prevent loss of the dry erase marker.

6. The dry erase board for use with a stretcher or hospital bed according to claim 5
wherein the non-erasable indicia are textual and/or graphical sentiments appearing on the marking surface;
wherein the non-erasable indicia are permanent in the sense that the non-erasable indicia remains on the marking surface after erasing marks left by the dry erase marker;
wherein the sentiments expressed by the non-erasable indicia are adapted to prompt the caregivers to add information relevant to the care of the patient using the dry erase marker.

7. The dry erase board for use with a stretcher or hospital bed according to claim 6
wherein the non-erasable indicia are silk-screened onto the marking surface using a paint that bonds permanently with the marking surface once the paint has dried.

8. The dry erase board for use with a stretcher or hospital bed according to claim 6
wherein the plurality of prompts are organized and grouped such that the plurality of prompts are adapted to communicate messages and status to both the caregivers and to the patient.

9. The dry erase board for use with a stretcher or hospital bed according to claim 8
wherein the plurality of prompts prompt for a current date and names of care providers.

10. The dry erase board for use with a stretcher or hospital bed according to claim 8
wherein the plurality of prompts prompt for safety information.

11. The dry erase board for use with a stretcher or hospital bed according to claim 8
wherein the plurality of prompts prompt for treatment decisions.

12. The dry erase board for use with a stretcher or hospital bed according to claim 8
wherein the plurality of prompts prompt for labs.

13. The dry erase board for use with a stretcher or hospital bed according to claim 8
wherein the plurality of prompts prompt for medication and IV fluids.

14. The dry erase board for use with a stretcher or hospital bed according to claim 8
wherein the plurality of prompts prompt for a discharge/admission decision.

15. The dry erase board for use with a stretcher or hospital bed according to claim 8
wherein the plurality of prompts prompt for notes.

16. The dry erase board for use with a stretcher or hospital bed according to claim 8
wherein the plurality of prompts prompt for treatment timing.

17. The dry erase board for use with a stretcher or hospital bed according to claim 8 wherein the mount is operable to detachably couple the dry erase board to the patient conveyance;
wherein the mount is coupled to the rear of the dry erase board;
wherein the mount comprises a ball joint and a clamp.

18. The dry erase board for use with a stretcher or hospital bed according to claim 17
wherein the ball joint is operable to change the elevation angle, the azimuth angle, or both between the dry erase board and the patient conveyance;
wherein the ball joint permits the dry erase board to be repositioned when an adjustment knob is rotated to loosen the ball joint;
wherein the ball joint prevents the dry erase board to be repositioned when the adjustment knob is rotated to tighten the ball joint;
wherein the clamp is opened to couple the mount to the patient conveyance and is closed to retain the mount to the patient conveyance.

19. The dry erase board for use with a stretcher or hospital bed according to claim 18
wherein the digital clock is a time-keeping device coupled to the front of the dry erase board;
wherein the digital clock displays the local time.
